(19) United States
(12) Patent Application Publication
(10) Pub. No.: US 2005/0278222 A1
(43) Pub. Date: Dec. 15, 2005

(54) Systems and methods for performing transactions

(76) Inventor: Edward H. Nortrup, Stoneham, MA (US)

Correspondence Address: STRATEGIC PATENTS P.C.., C/O PORTFOLIOIP, P.O. BOX 52050, MINNEAPOLIS, MN, 55402, US

(21) Appl. No.: 11/136,709

(22) Filed: May 24, 2005

Related U.S. Application Data
(60) Provisional application No. 60/573,951, filed on May 24, 2004.

(51) Int. Cl. G06F 17/60

(52) U.S. Cl. 705/17; 705/24; 340/572.1; 235/375

(57) ABSTRACT

An aspect of the present invention relates to improved systems and methods for making transactions. In an embodiment such systems and methods may involve providing printed information pertaining to at least one transaction; providing an RFID tag wherein the RFID tag includes electronic information pertaining to the at least one transaction; providing an interrogation facility; and causing the interrogation facility to interrogate the RFID tag and receive the electronic information.

### RELATED APPLICATIONS

This application claims the benefit of U.S. Provisional Patent Application No. 60/573,951, entitled “Systems and Methods for Performing Transactions,” filed May 24, 2004, the entire contents of which are incorporated herein by reference.

### BACKGROUND

1. Field of the Invention

The present invention relates systems and methods for performing transactions. More particularly, in embodiments, systems and methods for performing economic and non-economic transactions are described. In embodiments, systems and methods relate to performing secure transactions.

2. Description of Related Art

The process of using a credit card to perform transactions comes with the potential of exposing the account owner to identity fraud and economic theft. While credit cards are convenient, there are many drawbacks to there use. It would be useful to provide improved methods of performing transactions. The present invention relates to improved systems and methods for performing economic and non-economic transactions.

### SUMMARY OF THE INVENTION

An aspect of the present invention relates to systems and methods of providing transaction information. In embodiments, the systems and methods may include providing printed information pertaining to at least one transaction; providing an RFID tag wherein the RFID tag includes electronic information pertaining to the at least one transaction; providing an interrogation facility; and causing the interrogation facility to interrogate the RFID tag and receive the electronic information.

An aspect of the present invention relates to providing an electronically readable bill. In embodiments, the bill includes printed transaction information; and an RFID tag with electronic information pertaining to the transaction.

An aspect of the present invention relates to a bill transaction facility. In embodiments, the bill transaction facility includes an interrogation facility adapted to initiate RFID communication and read RFID transaction information; and a computing facility adapted to store the transaction RFID information, present the transaction information on a display facility, and communicate the transaction information to a payment facility.

An aspect of the present invention relates to systems and methods of performing an economic transaction. In embodiments, the systems and methods involve providing a transaction check incorporating an RFID tag; causing authentification information to be stored on the RFID tag; and interrogating the RFID tag to authenticate the check.

An aspect of the present invention relates to systems and methods of sorting mail. In embodiments, the systems and methods involve providing an interrogation facility; providing mail in proximity to the interrogation facility; and causing the interrogation facility to interrogate the mail and identify at least one characteristic of the mail.

An aspect of the present invention relates to systems and methods for sorting mail. In embodiments, the systems and methods involve providing a registration list; approving list registrants; providing an authorization code to the list registrants wherein the registrants store the authorization code on RFID tags associated with mail sent by the registrant; and sorting the mail according to the authorization code.

An aspect of the present invention relates to systems and methods of fraud prevention. In embodiments, the systems and methods involve taking a credit card number for a transaction; and contemporaneously with the transaction, communicating to a device of the holder to indicate use of the credit card.

An aspect of the present invention relates to systems and methods of fraud prevention. In embodiments, the systems and methods include, upon receiving an application for a credit card, contemporaneously communicating to a device of the individual named in the application to verify the desire to apply for the card.

An aspect of the present invention relates to systems and methods of preventing fraud. In embodiments, the systems and methods involve accepting entry of a password for accessing secure content, and if the password is not valid, presenting alternate content to the party that entered the invalid password.

### BRIEF DESCRIPTION OF THE FIGURES

The following figures depict certain illustrative embodiments of the invention in which like reference numerals refer to like elements. These depicted embodiments are to be understood as illustrative of the invention and not as limiting in any way.

FIG. 1 illustrates a transaction security facility according to the principles of the present invention.

FIG. 2 illustrates a transaction security facility schematic according to the principles of the present invention including handling of economic and non-economic transaction information.

FIG. 3 illustrates notification methods according to the principles of the present invention.

FIG. 4 illustrates a wireless information portal receiving a transaction notification according to the principles of the present invention.

FIG. 5 illustrates a menu system associated with a transaction notification according to the principles of the present invention.

FIG. 6 illustrates a transaction filter according to the principles of the present invention.

FIG. 7 illustrates a portable communication facility with an approval recognition facility according to the principles of the present invention.

FIG. 8 illustrates a self-identifying transaction facility.

FIG. 9 illustrates a person performing a transaction using methods and systems according to the principles of the present invention.

FIG. 10 illustrates a transaction facility according to the principles of the present invention wherein the transaction facility includes a switch facility for selecting one of a plurality of partitioned information.

FIG. 11 illustrates a transaction facility with a verification facility according to the principles of the present invention.

FIG. 12 illustrates a transaction facility with an on/off switch according to the principles of the present invention.

FIG. 13 illustrates a method of performing a transaction using transaction facility wherein the transaction facility is a cell phone, BlackBerry, PDA other portable communication facility according to the principles of he present invention.

FIG. 14 illustrates a method of performing a transaction using a transaction facility wherein the transaction facility is a cell phone, or other portable transaction facility or communication facility, including a facility capable of communicating through an interrogation signal and the transaction involves reading an RFID tag from a bill.

FIG. 15 illustrates a method of communicating transaction information according to the principles of the present invention.

FIG. 16 illustrates a bill with an RFID tag according to the principles of the present invention. In embodiments, the RFID tag associated with the bill contains information relating to the bill.

FIG. 17 illustrates a transaction information collection facility according to the principles of the present invention.

FIG. 18 illustrates systems and methods used to manipulate and or communicate data collected from the transaction information collection facility according to the principles of the present invention.

FIG. 19 illustrates a transaction information collection facility including an indication facility according to the principles of the present invention.

### DETAILED DESCRIPTION

The description below pertains to several illustrative embodiments of the invention. Although many variations of the invention may be envisioned by one skilled in the art, such variations and improvements are intended to fall within the compass of this disclosure. Thus, the scope of the invention is not to be limited in any way by the disclosure below.

An aspect of the present invention relates to performing secure transactions. In embodiments, the secure nature of the transaction is provided through notification of certain transactions relating to an individual, business or other person interested in tracking, protecting, and possibly approving certain transactions. For example, a person may want to track the use of his credit card and a notification or approval request may be sent to his cell phone every time such transaction is performed or attempted. In embodiments, transactions that are not approved may be tracked or otherwise reported. In embodiments, a user may be interested in protecting economic transactions, such as credit card or bank transactions. In embodiments, a user may want to protect non-economic transactions, such as those associated with the users credit information or information used when an account is being opened for the user or on behalf of the user. For example, the user may want cell phone notification every time a credit card application is generated in his name or with his social security number. In embodiments, this may be accomplished through a registry where the user's cell phone number is listed.

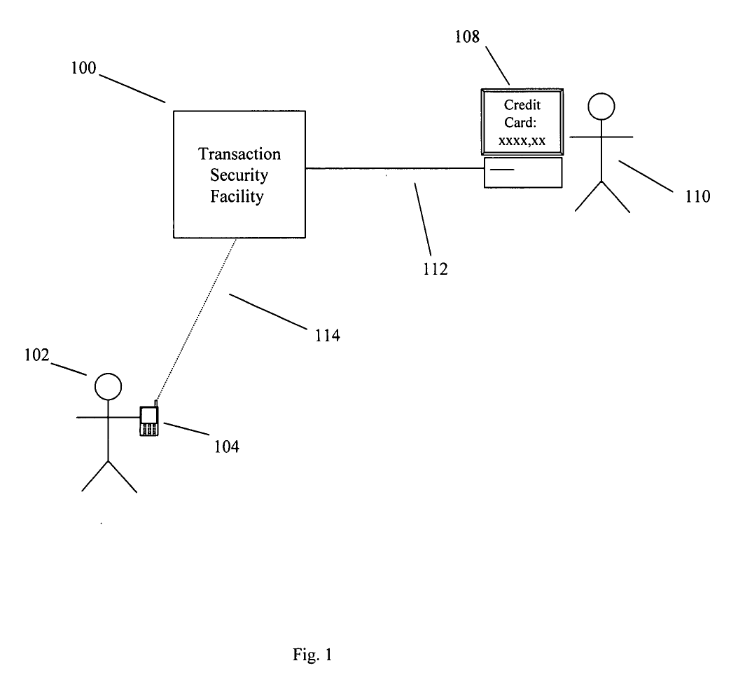

FIG. 1 illustrates an embodiment of the present invention where a non-account owner person 110 makes a transaction through a transaction facility 108. The transaction facility 108 may communicate the transaction information to or through a security facility 100 and the security facility 100 may communicate information relating to the transaction to the user's 102, or account owner's, cell phone 102 or other designated communication facility.

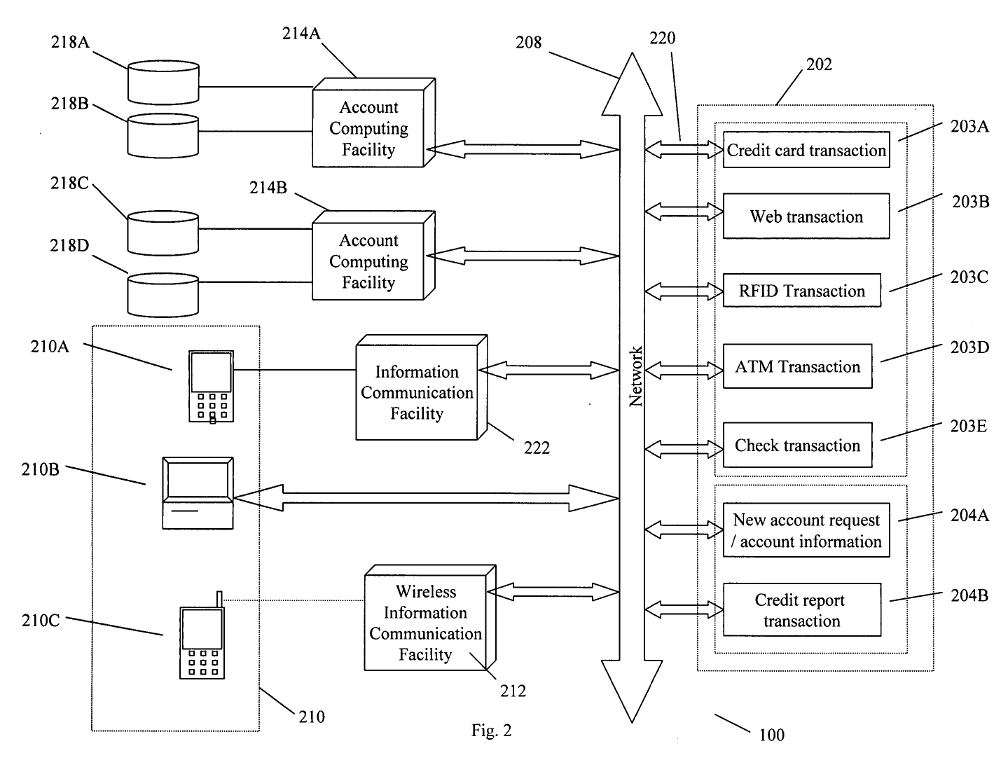

FIG. 2 illustrates a schematic representation of a security transaction facility 100. In this embodiment, account transaction information 202 may be transmitted to the transaction facility 100. The account transaction information 202 may be economic 230 in nature or non-economic 204 in nature. For example, economic information may relate to credit card transactions 203A, web transaction 203B, RFID transaction 203C, ATM or bank transaction 203D, check transaction 203E or other transaction relating to economic transactions. In another example, non-economic transaction information may relate to a new account request or account information request 204A, credit report interactions or listings or edits 204B, or other non-economic transactions. In embodiments, the transaction information 202 may be communicated 220 through a network 208 to an account computing facility (or facilities) 214. For example, the transaction may have been a credit card transaction and the communication may lead to communications and approvals through a banking facility that is associated with a database(s) 218.

In embodiments, transaction information, the fact that one occurred, or an approval request may be communicated to an information portal 210. For example, information relating to a transaction may be communicated through a network communication facility 222 to an information portal such as a phone 210A or computer 210B. In an embodiment, the information may be communicated through a wireless communication facility 212 to a wireless information portal 210C, such as a cell phone, Blackberry, PDA, instant messaging facility, email facility, or other wireless communication facility.

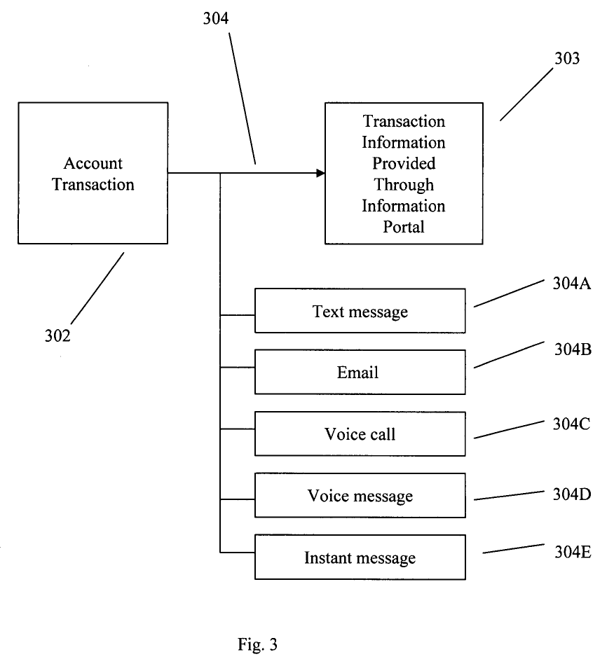

FIG. 3 illustrates notification methods 304 according to the principles of the present invention. In this embodiment, the information pertaining to a transaction 302 may be communicated to an information portal 303 through text messaging 304A, email 304B, a voice call 304C, voice messaging 304D, instant messaging 304E, or other methods of communication.

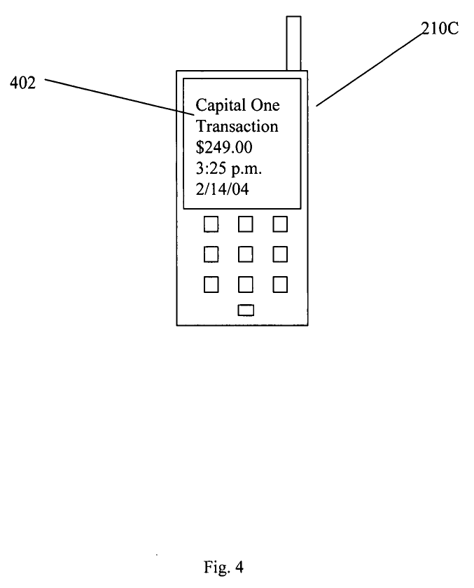

FIG. 4 illustrates a wireless information portal 210C receiving a transaction notification 402 according to the principles of the present invention. In embodiments, transaction notifications may be communicated to an information portal, such as a cell phone. For example, following a transaction, a notification may be sent to the account owner's cell phone and the notification may be displayed on the cell phone display, sent to the voice mail phone, sent as a voice call or otherwise provided.

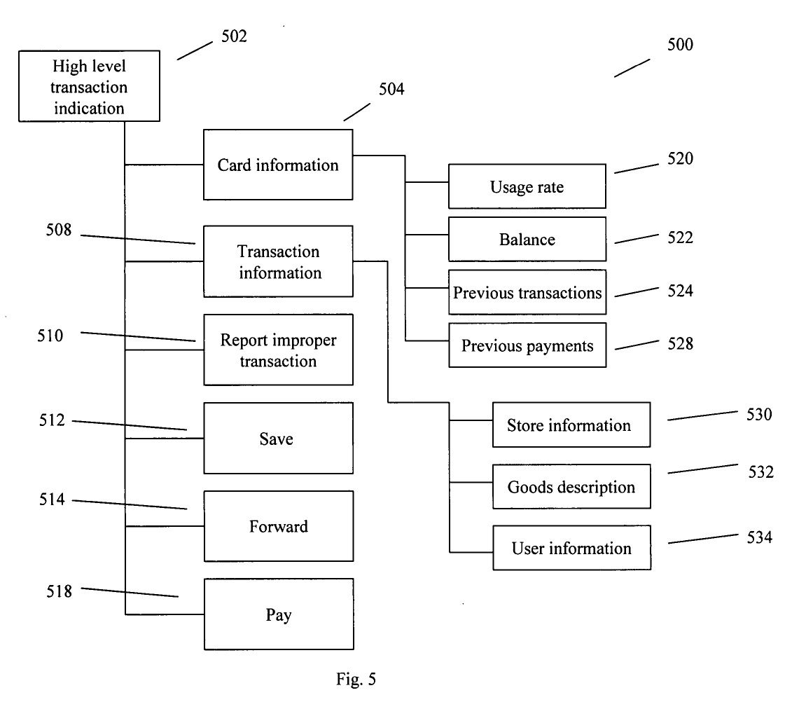

FIG. 5 illustrates a menu system associated with a transaction notification according to the principles of the present invention. Following the high level transaction indication 502, a menu of options may be provided. For example, through the menu, card or other account information may be obtained 504, information pertaining to the transaction 508, actions such as reporting an improper transaction 510, saving the transaction 512, forwarding the transaction information 514, sending payment instructions for the transaction 518, or other information or actions relating to the transaction. In embodiments, the menu options may have sub-options. For example, the account information menu option 504 may have sub-options such as usage rate 520, balance 522, previous transaction information 524, previous payment information 528, or other information relating to account information. As another example, the menu option to obtain transaction information 508 may have sub-options such as storing the information 530, obtaining a description of the goods 532, obtaining user information 534, or obtaining other information relating to the transaction.

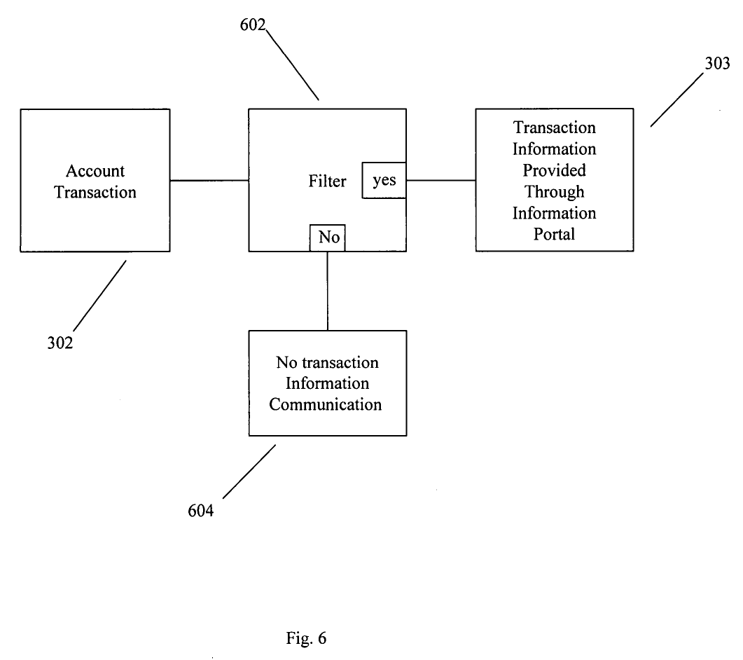

FIG. 6 illustrates a transaction filter 602 according to the principles of the present invention. In embodiments, a filter may be provided to either pass notification to an account owner or not. For example, a transaction notification may be provided through a non-filtered system, such that all or substantially all relevant transactions are sent through the notification system. In an embodiment, a filter may be used to filter certain transactions from being communicated through the notification system. For example, transactions relating to particular events, amount levels, dates, proximity to the portable communication facility or the like may be blocked by the filter. In an embodiment, a portable communication facility (e.g. cell phone) may be used and its location may be determined, through cell phone communication triangulation, GPS location, or other means. If the location of the portable communication facility is within a certain distance (e.g. five meters, one hundred meters, etc.) of the transaction location the notification of the transaction may be filtered. The transaction location may be determined through the payee information as transmitted to the users account transaction facility for example. In the event of a web transaction, the location may be determined as ‘web’ and notification may be sent, for example.

Another aspect of the present invention relates to approving transactions. In embodiments, systems and methods of approving transactions with security techniques are presented. For example, prior to a transaction being executed, approval through an automated approval/recognition facility may be required. In embodiments, a cell phone, or other portable communication facility, may be used in the process of approving a transaction and the cell phone may include a self or user recognition system. For example, the cell phone may include a fingerprint recognition facility (e.g. through the cell phone display or a recognition facility separate from the cell phone display) and a transaction notification may be sent to the user's cell phone. Upon receipt of such notification, the user may be prompted through the cell phone to approve or disapprove the transaction. Approval may be obtained through the fingerprint recognition facility. The user may simply place a finger on the print-recognition facility and, upon recognition, the transaction may be approved. In embodiments, the recognition software may be loaded in the portable communication facility and the recognition procedure may be completed in the communication facility. In embodiments, the communication facility may be used to collect data that will be used by another facility to complete the recognition and or approval process. For example, the portable communication facility may collect data from a fingerprint data collection facility and the data may be transmitted to another facility to perform the verification/recognition.

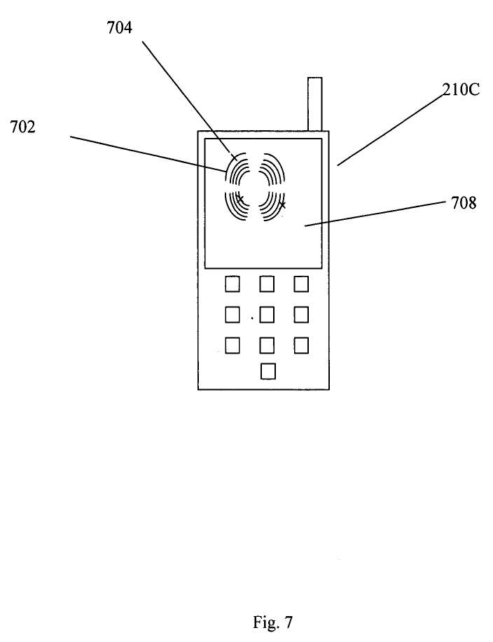

FIG. 7 illustrates a portable communication facility 210C with an approval recognition facility according to the principles of the present invention. In this embodiment, the cell phone 210C includes a display 708. The display may be used as part of a finger print recognition facility where a finger is placed on the display 708 to allow a software generated recognition system to record data 704 associated with the print 702. In embodiments, the data collected may be processed and compared to the user's preloaded information. In embodiments, the data may be collected from the print and then the data may be communicated to another facility for processing. For example, the data may be communicated to the users account transaction facility and the facility may compare the data with the user's preloaded print information. Once a match is made between the data collected and the print, the transaction may be approved. In embodiments, the approval process may require one or more other affirmative steps to approve the transaction, such as pressing a particular number on the keypad. In embodiments, the authentification or recognition facility may be a fingerprint recognition facility separate from the display 708.

In embodiments, a portable communication facility with an identification facility may be used in the process of a transaction to secure the transaction. For example, a person may be performing an economic or non-economic transaction using the persons account information, such as making a purchase on-line using the person's credit card. The secure process may involve the person entering credit card information relating to the transaction of the purchase of goods. Once the credit card information is communicated, the account transaction facility associated with the credit card verifies account information (e.g. finds the account and verifies the owner or permitted users as well as verifies fund availability) and then communicates to the user's cell phone. The user then uses the cell phone to identify himself through an identification facility (e.g. fingerprint analysis). In an embodiment, the verification is performed at the local portable facility and a verification communication is sent back to the account facility to either continue or terminate the transaction. In an embodiment, data collected from the identification facility is communicated back to the account facility, or other facility, for verification of identity. Once the identity is verified, the transaction can proceed.

In a embodiments, the identification facility may be a finger print identification facility, a signature identification facility, a feature identification facility, a facial feature identification facility, a voice identification facility, or other facility used in the identification or verification of a user. In embodiments, the identification facility may include or have access to a database of one or more user identities that may be used during the identification or verification process. For example, the identification facility may be preloaded with four different people's fingerprints to allow for identification and or verification of the four different people. In embodiments, the identification facility may be associated with an identification database through a network. For example, pattern recognition data may be collected locally (e.g. through the cell phone) and the data may be transmitted to an identification database where matches may be searched. Identification information may then be transmitted back to the local data collection facility or other facility nearby.

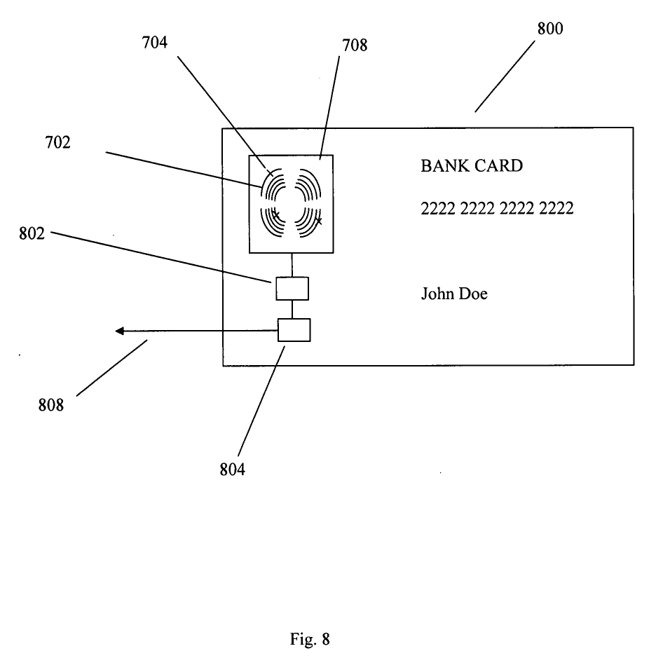

An aspect of the present invention relates to providing secure transactions through the use of a self-identifying transaction facility. In embodiments, a user's credit, bank or other account information may be preloaded into a self-identifying transaction facility (e.g. a credit card) and the activation, or release, of the account information may be produced only upon on the identification of the owner or associated permitted users. For example, FIG. 8 illustrates a self-identifying transaction facility 800. The self-identifying transaction facility 800 includes an RFID tag 804 or other storage and communication facility for communicating the account information. The self-identifying transaction facility 800 also includes an identification facility 708. The identification facility 708 may include a computing facility 802 and be associated with the RFID tag 804. In embodiments, the RFID tag may release information upon verification of the owner or approved user. While embodiments refer to an RFID tag, other communication facilities may be used. For example, rather than wireless communication, the information communication may be through connected communication methods.

In embodiments, the identification facility may include an OLED screen or other thin screen or sensors placed through an area to sense patterns (e.g. fingerprint patterns or signature patterns). For example, the sensors may be adapted to sense pressure of fingerprint lines and or valleys, conductivity to recognize lines and or valleys. In embodiments, sensors may be adapted to capture an image of a fingerprint or signature. In embodiments, a thin screen or other identity recognition facility may be used to keep the card thin to approximate the look and feel of a standard credit card.

In embodiments, a credit card, or other transaction facility, may be provided and it may include an owner recognition facility (e.g. fingerprint recognition facility). In embodiments the owner recognition facility may be powered by an on-board battery and or through an interrogation signal. For example, a credit card may be provided and the credit card may include a fingerprint recognition/verification facility. The fingerprint recognition/verification facility may be energized through the activation of an interrogation signal or some other form of inductive, magnetic, electric field or electromagnetic energizing method. In embodiments, the amount of processing completed on-board the card may be minimized by reducing the amount of process and data collection required on the card. For example, the print recognition facility may only be required to collect data from the print and then the data, possibly along with account information, may be communicated through the RFID tag or through other wireless communication means. The process may involve placing the card in proximity with a power signal (e.g. interrogation signal) to energize the processor or other electronics on the card, the user places his finger on the recognition pad, and the recognition facility collects data associated with the finger. Once the data is collected, the data may be communicated to another facility. The other facility, possibly the owner's account transaction facility, may process the data and compare it with known information related to the print and verify or deny the identity of the person that supplied the data. In an embodiment, the print data may be accompanied by account or other identification data to allow the other system to look up relevant information related to the card owner. In an embodiment, the print data may come and the print may be compared with a plurality of prints to determine the identity of the person supplying the print data.

While many of the embodiments described herein disclose the use of fingerprint recognition for purposes of account transaction approval or for other means, it should be understood that other authentification systems may be used in systems and methods according to the principles of the present invention. In embodiments, an authentification or recognition system may be based on voice recognition, feature recognition, sent recognition, signature recognition, DNA recognition, biometric information recognition or other features that may be measured and or compared to perform a recognition or authentification of a user and or owner.

Another aspect of the present invention relates to wireless communication of transaction information. In embodiments, wireless communication facilities are used to facilitate transactions. For example, an RFID tag and interrogation facility designed to extract information from the tag may be used in a transaction. In embodiments, the RFID transaction may be secured through approval facilities in association with electronic keys. For example, an interrogation transmission may be communicated in the direction of a user's transaction RFID tag. The tag may not emit its stored information until an approval is received through a manual or automatic approval facility. In an embodiment, the tag may communicate automatically if the interrogation transmission contains the proper initiation signal or key. For example, the RFID tag may have a data receiver and the interrogation facility may be configured to transmit an interrogation signal (e.g. a transmission designed to energize the RFID tag circuit) as well as to transmit data (e.g. key information to be read by the RFID tag). The RFID tag circuit may be energized by the interrogation signal and then adapted to read data. The data may contain ‘key’ information and if it matches the ‘key’ information in the RFID tag memory, the RFID tag may transmit information. In embodiments, the type of information transmitted may be associated with the type of key information received. For example, the key information may be of the kind that only releases the RFID tag owners name and address, but not credit card or other more sensitive information. In embodiments, the RFID tag is reconfigurable, such as when new information needs to be loaded or the key information needs to be changed. For example, the RFID tag may reconfigure its key following a transaction or at another appropriate time.

While many of the embodiments herein disclose the use of transaction RFID facilities, it should be understood that certain embodiments may use other communication techniques such as infrared, radio frequency, electromagnetic, or other techniques.

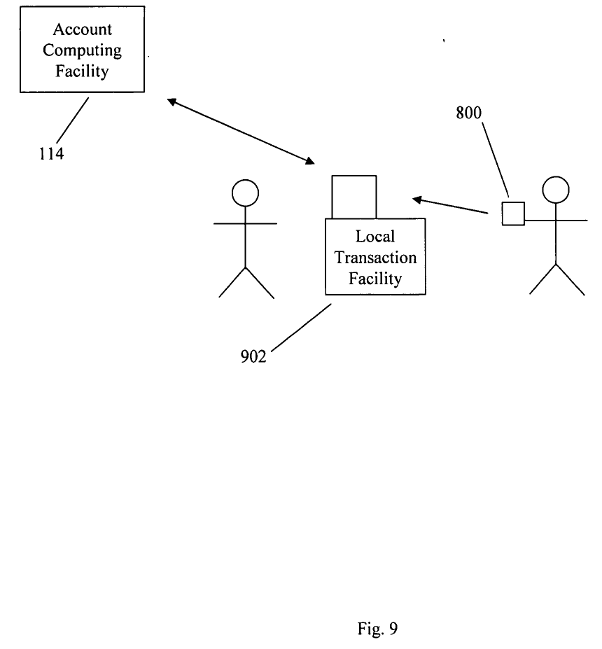

FIG. 9 illustrates a person performing a transaction using methods and systems according to the principles of the present invention. In this embodiment, a person may be using a credit card as describe in connection with FIG. 8. The person may pay for goods through a local transaction facility 902. The transaction may be initiated by the user performing a recognition procedure to release the card information to the local transaction facility. Once the information is transferred to the local transaction facility, the users account facility may be accessed to complete the transaction.

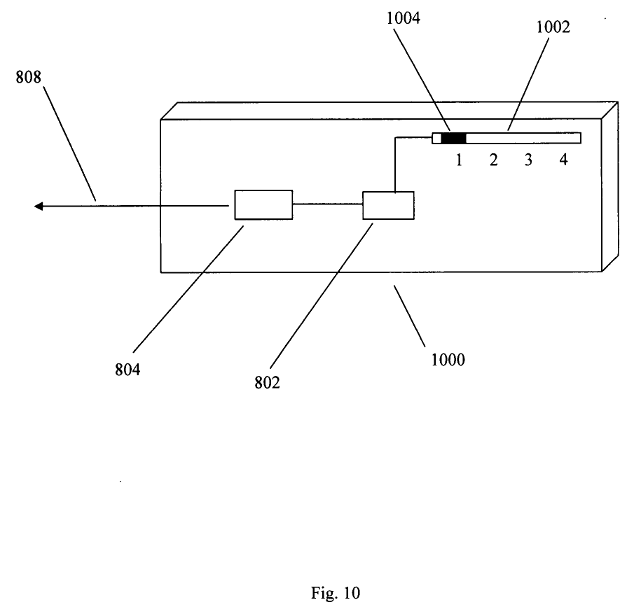

FIG. 10 illustrates a transaction facility 1000 according to the principles of the present invention wherein the transaction facility 1000 includes a switch facility 1002 for selecting one of a plurality of partitioned information. In this embodiment, the transaction facility includes a computing facility 802 and a communication facility 804 (e.g. an RFID tag). The computing facility 802 may include partitioned data that is accessible through the setting of the switch 1004 on the switch facility 1002. For example, the switch 1004 may be used to select or enable the data associated with the first partition and the first partitioned data may be communicated 808 through the RFID tag upon activation of the tag through an RF interrogation signal. When the switch 1004 is set to a position associated with a second partitioned data, the RFID tag may communicate the second partitioned data upon request by an interrogation signal. Partitioned data may be used in situations where a user would like to select the data transmitted upon interrogation. For example, a user may associate a first partition with his Visa card, a second partition with his ATM card, a third partition to personal identification information (e.g. social security number, address, birth date, mother's maiden name, etc.), a fourth partition to a sub set of personal identification information, a fifth partition disabling the communication from the RFID, a sixth partition containing information to be communicated in the event of an unwanted interrogation and the like. For example, the fourth setting of containing a reduced set of personal identification information may be used in situations where the owner of the transaction facility only wants his name and address produced but the rest of the information retained securely. At another time, when applying for a credit card for example, the user may want more personal information available to be produced. An example of when the sixth partition may be used is when the owner of the transaction facility wants to communicate information to the system, company or individuals interrogating the transaction facility. This may be a communication requesting the owner's name be listed on a no communication list, privacy list, or other communication indicating no further interaction with this owner is desirable and if received, the information is to remain confidential. In such an event, the receiver of the information may also be prompted or otherwise required to send a notification communication to the owner indicating such actions have been taken.

In an embodiment, the transaction facility 1000 may include an indicator, or other notification facility, indicating the transaction facility communicated information or received an interrogation. For example, the indicator may be a light (e.g. LED) or a screen (e.g. LCD, Plasma, OLED). The indicator may have persistence to provide not only information during the transaction or interrogation but information following the transaction or interrogation. The transaction facility may also be enabled with a storage facility such that the storage facility captures information relating to transactions and interrogations. The information stored in the storage facility may than be accessed to provide the transaction facility owner with information relating to transaction communications and interrogations. In an embodiment, the transaction facility may also include an interrogation facility or other communication receiving facility of its own. For example, the transaction facility may not release any information through the RFID tag until it receives a signal from the interrogation facility. The received signal may come as an unprompted IR, RF or other signal or it may come as a result of the transaction facilities own interrogation. The received signal may come with authorization or verification information in an embodiment. For example, the communication may include verified data. The verification may be from a registered list of acceptable or approved vendors of such signals. The user may elect to override the process and manually release the information requested if the interrogation signal is not verified in an embodiment.

In an embodiment, a user may use a cell phone equipped with an interrogation facility or other electromagnetic communication facility to receive information from the transaction facility. For example, a user may use a cell phone, or other communication facility or portable communication facility, to receive information from the transaction facility. The information may be information pertaining to the history of interrogations and or communications.

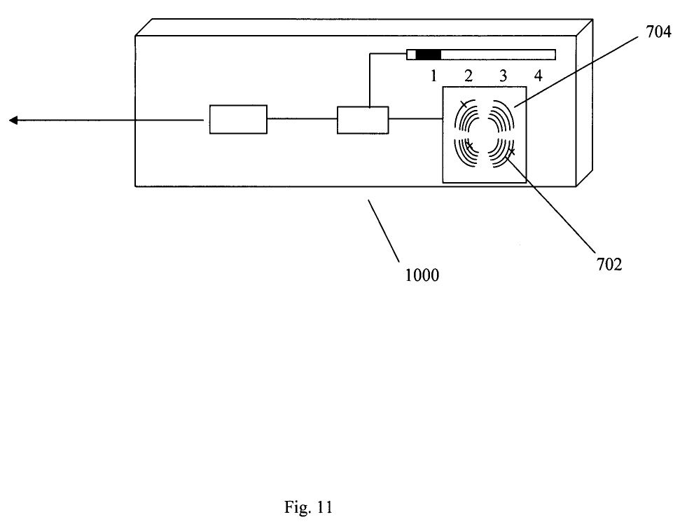

FIG. 11 illustrates a transaction facility 1000 with a verification facility 704 according to the principles of the present invention. The verification facility 704 may be a fingerprint recognition facility, signature recognition facility, voice recognition facility, DNA recognition facility or other recognition facility. In an embodiment, the verification facility may be used to secure all or certain transactions. For example, before transmitting information relating to the owner's Visa account, the verification facility may be used to verify the user's identity. In an embodiment, the verification facility may not be required on all partition settings. For example, when a sub set of personal information is selected via the switch 1004, the information may be freely provided without the requirement of verification of the user.

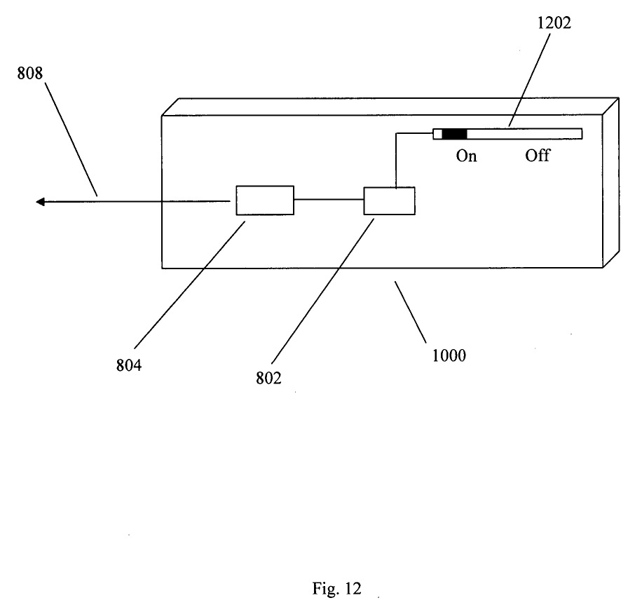

FIG. 12 illustrates a transaction facility 1000 with an on/off switch according to the principles of the present invention. For example, a user may have stored information in the transaction facility and may want to disable the transmitter from providing the information during an interrogation or a certain interrogation. In an embodiment, information may still be provided even when the switch is in the off position if the interrogation is from a verified source. In an embodiment, no information is provided to any interrogation facility in the event the switch is in the off position.

An aspect of the present invention relates to systems and methods for performing transactions through a portable transaction facility. In embodiments, a portable communication facility is adapted as a portable transaction facility. The portable transaction facility may function as a communication facility and or a transaction facility facilitating economic or non-economic transactions. For example, a portable communication facility (e.g. a cell phone) may be equipped with an RFID transmitter, RFID interrogation system, IR communication facility, local RF communication facility, RF communication facility, or other communication facility and be adapted to communicate transaction information in order to facilitate a transaction. In embodiments, the cell phone may have pre-stored transaction and or account information and or have access to such information (e.g. through cell phone network communications) and the information may be used and or communicated during a transaction. In embodiments, the cell phone may be adapted to receive certain transaction information (e.g. receipt of RFID tag information through an interrogation facility, or receipt of transaction information through IR and or RF communications).

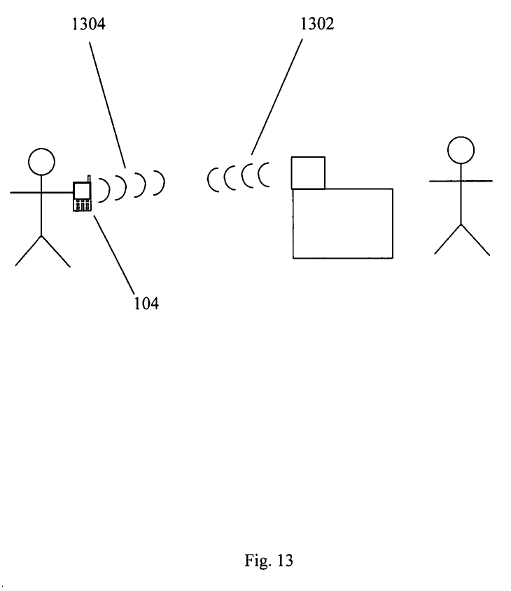

FIG. 13 illustrates a method of performing a transaction using a transaction facility wherein the transaction facility is a cell phone 104, BlackBerry, PDA other portable communication facility according to the principles of he present invention. In embodiments, a cell phone is equipped with a transaction facility. For example, the cell phone may be equipped with an RFID communication facility, IR communication facility, RF communication facility or other wireless communication facility and the communication facility may be associated with memory containing transaction and or account information. The communication facility may be adapted to communicate with another transaction facility (e.g. a cashier checkout station). For example, the cell phone may be adapted to communicate the owners account information through an RFID tag and the checkout station may be equipped with an interrogation facility. The owner of the cell phone passes the cell phone in proximity of the interrogation facility where the interrogation facility communicates an interrogation signal 1302 and in response the cell phone's RFID tag communicates the account information 1304. In embodiments, the communication from the cell phone is through wireless means other than RFID. For example, the cell phone may be equipped with an IR or RF port, including but not limited to the cell phone's standard communication antenna. An owner may then cause the cell phone to communicate account information to the point of the transaction (e.g. a cashier checkout station). In embodiments, the method of communicating the account information may include local communication methods. For example, the IR or RF transmission signal may be communicated with a low power level such that the proximity between the transmitter and receiver are required to be relatively close. In embodiments, the method of communicating the account information may include using a cell phone network. For example, the point of transaction may have a phone number or other unique identification and the user may cause the cell phone to initiate account and or transaction information through the cell phone network to the unique identifier, possibly including communication through the owner's account transaction facility. The account transaction facility may be used to verify that the communication came from the verified cell phone for example. In an embodiment, the cashier checkout station, or other such facility, may communicate information to the owners account transaction facility, then the account transaction facility may communicate transaction information to the cell phone and then the cell phone may be required to transmit final information to the cashier in order to complete the transaction.

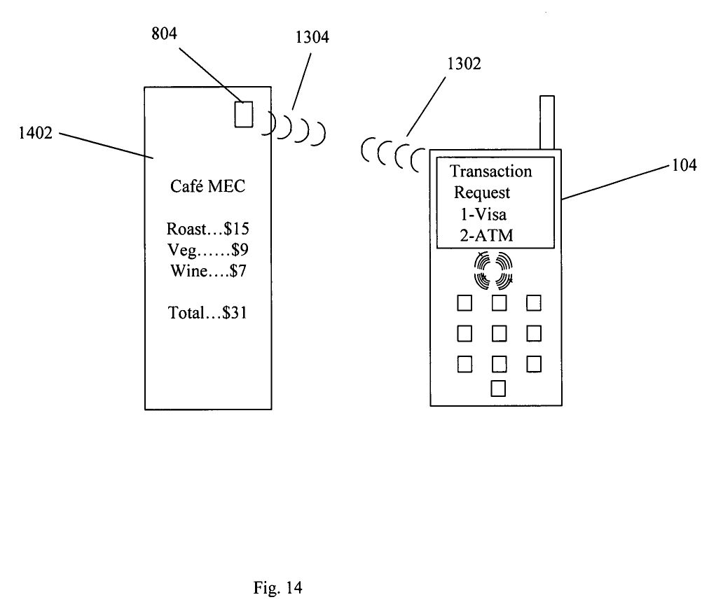

FIG. 14 illustrates a method of performing a transaction using a transaction facility wherein the transaction facility is a cell phone 104, or other portable transaction facility or communication facility, including a facility capable of communicating through an interrogation signal 1302 and the transaction involves reading an RFID tag 804 from a bill 1402. In embodiments, a bill 1402 arrives at a restaurant table and the customer uses his cell phone to perform the transaction. For example, the cell phone, with its interrogation facility, interrogates the bill's RFID tag and the tag responds by communicating information relating to the bill. The RFID tag may communicate information relating to the transaction including: transaction amount, items, tax, payee information and or other information related to the transaction. Once the transaction information is received, the user may calculate a tip, assess the transaction for accuracy and or manipulate the information. The user may then cause payment information to be communicated to complete the transaction. In embodiments, the payment information may be communicated locally (e.g. to a waiter with a wireless communication facility, or to a central payment facility). In embodiments, the payment information may be communicated through a cell phone network to the owners account transaction facility and to the payee to complete the transaction.

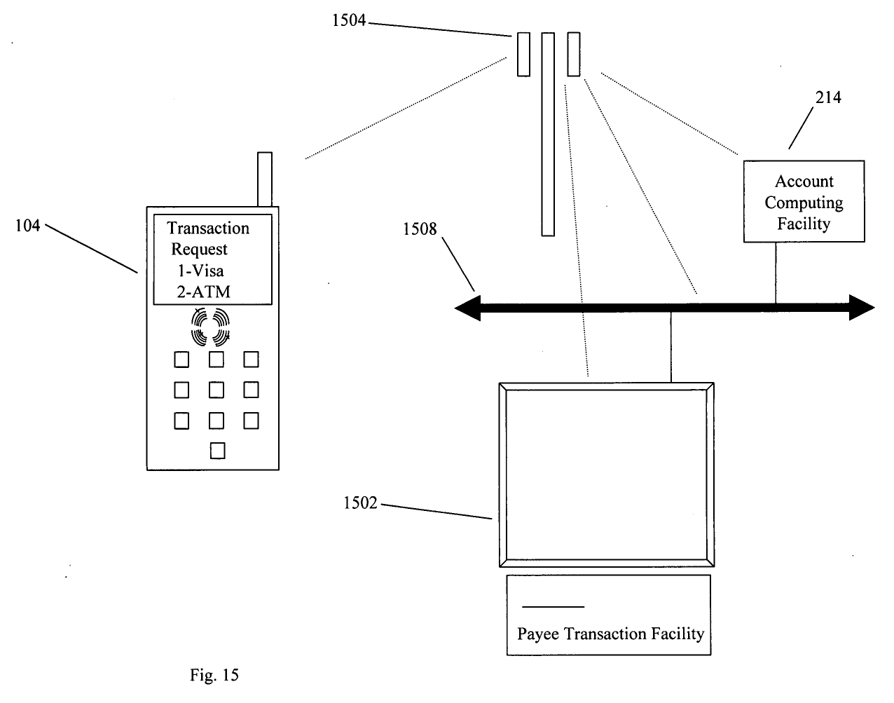

FIG. 15 illustrates a method of communicating transaction information according to the principles of the present invention. In an embodiment, the transaction facility incorporated into the portable communication facility 104 collects transaction information (e.g. RFID transaction) and communicates the transaction information through a cell phone network 1504. The information may be directed to the owner's account computing facility 214, to a network 1508, and or to a payee transaction facility 1502. If the initial communication is to the account computing facility 214, the following process may include approving the transaction and communicating payment information to the payee transaction facility 1502 and or communicating confirmation or other information to the portable communication facility 104 or to another communication facility determined by user.

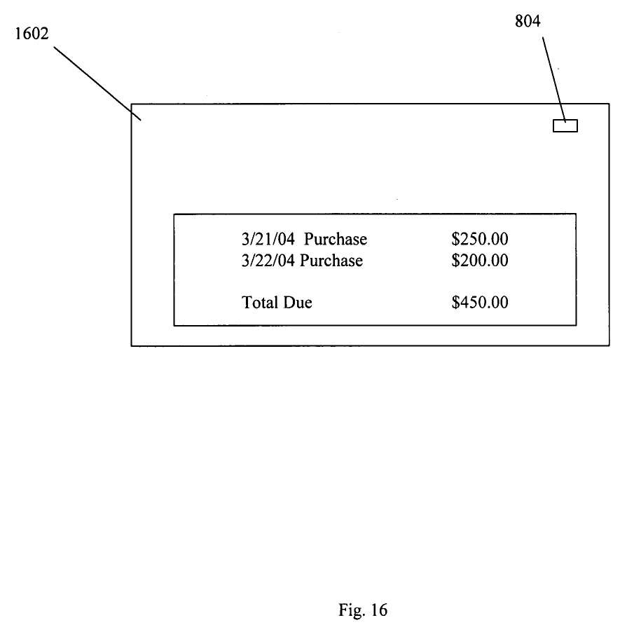

FIG. 16 illustrates a bill 1602 with an RFID tag 804 according to the principles of the present invention. In embodiments, the RFID tag 804 associated with the bill 1602 contains information relating to the bill 1602. For example, the bill 1602 may have been sent from an account owner's credit card company, electric company, oil company, gas company, bank, or other facility associated with sending a bills. The RFID tag may include payee information, transaction information, debtor information, or other information related to transactions, accounts, associations or other information. In embodiments, the tag may also include information relating to a security code or encryption data to provide security of the contained information. For example, the account owner may have a pass code, password, registered code or the like that may be required before the RFID tag will emit the information contained. This may be useful in preventing unauthorized users from gaining access to the information contained in the RFID tag. The account owner may have an interrogation facility capable of energizing and reading information from the bill's RFID tag. In embodiments, the interrogation facility includes and or communicates a key or code to the bill's RFID tag and upon activation and receipt of the code, the bill's RFID tag may communicate the information. In embodiments, an account user may import the transaction information from the bill's RFID tag to a bill paying facility and or a bill tracking/monitoring facility. For example, the owner may use a portable transaction facility (e.g. transaction facility incorporated into a cell phone as described herein) to read the bill's RFID tag information and also pay an amount and or make other account transactions/information request. Once the transaction information is loaded into the portable transaction facility the user may manipulate, pay, transfer, communicate, or otherwise interact with the information.

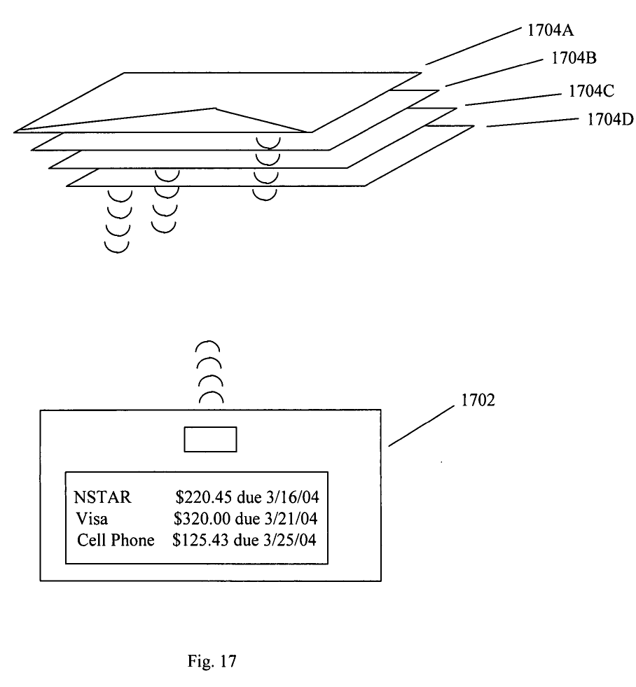

FIG. 17 illustrates a transaction information collection facility 1702 according to the principles of the present invention. In embodiments, the transaction information collection facility 1702 collects transaction information from bills including RFID tags 1704 in close proximity with the transaction information collection facility 1702. For example, a user may collect several pieces of mail 1704 and the user may waive one of the plurality of the mail 1704 in proximity of the transaction information collection facility 1702. Each piece of mail that includes an RFID tag (e.g. 1704A, C, and D in this embodiment) may transmit transaction information to the collection facility when brought in proximity of the collection facility or at sometime when the collection facility is so instructed to collect the information. Mail without an RFID tag (e.g. 1704B in this embodiment) will not transmit information. While many of the embodiments herein disclose transmission of transaction information, the collection facility may be adapted to collect other information as well. For example, the collection facility may be adapted to collect sweepstake, contest, credit card application, sales, vacation, or other information. In embodiments, such information may be partitioned and dealt with separately from the bill information collected. This may be useful to allow the user to view and interact with his bill information and then turn to dealing with the non-bill information. In embodiments, the collection facility is associated with a bill paying facility. For example, the information collected may be transferable into Quicken, Microsoft Money, online bill pay software, bank software, or other software capable of paying and or manipulating the transaction or account information. In embodiments, received application or other non-economic transaction information may be transferred into manipulation software as well. For example, a credit card application may be received and the information collected from the application may be transferable to the creditor's website to simplify the application process or the information may be transferable to an email, text messaging or other communication facility to facilitate the application process.

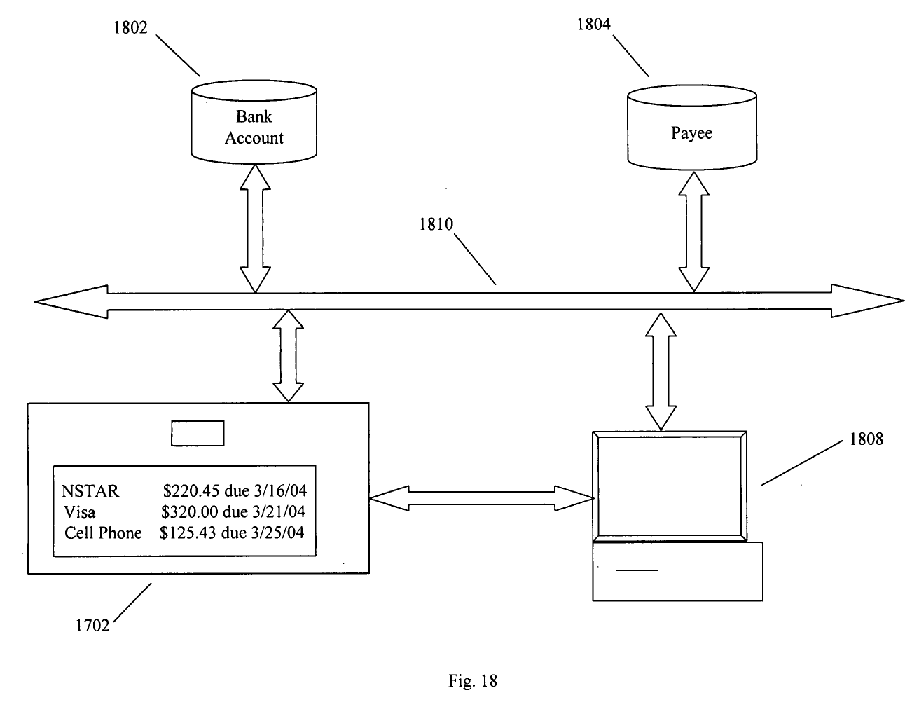

FIG. 18 illustrates systems and methods used to manipulate and or communicate data collected from the transaction information collection facility 1702 according to the principles of the present invention. In embodiments, the collection facility 1702 may communicate information collected to a personal computer, PDA, or other personal computing system 1808. In embodiments, the collection facility 1702 may communicate information collected to a bank computing facility 1802 through a network 1810. In embodiments, the collection facility 1702 may communicate information collected to a payee computing facility or a payee through other means (e.g. sending a check through the mail). These interactions may be facilitated through a network 1810 or be otherwise accomplished.

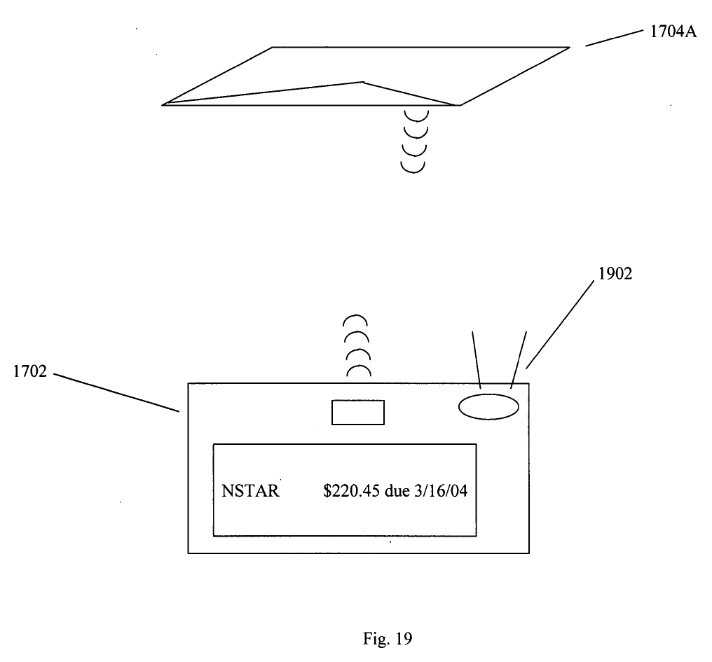

FIG. 19 illustrates a transaction information collection facility 1702 including an indication facility 1902 according to the principles of the present invention. In embodiments, the indication facility may be an indicator light, audio, screen, LCD screen, plasma screen or other indication facility used to provide information relating to the information collected by the collection facility. For example, the collection facility may include a screen and the screen may display information relating to the information collected. In an embodiment, the indication facility may be a light or audio indication of the type of mail (e.g. light up or generate sound when the information indicates it is a bill, credit application, bank statement, account summary, or other relevant information). In an embodiment, the sound indication may include a voice system. In an embodiment, the indication facility may be a display wherein the display is adapted to display relevant information relating to the collected information.

While the invention has been disclosed in connection with the embodiments shown and described in detail, various equivalents, modifications, and improvements will be apparent to one of ordinary skill in the art from the above description. Such equivalents, modifications, and improvements are intended to be encompassed by the following claims.

1. A method of providing transaction information, comprising:
providing printed information pertaining to at least one transaction;
providing an RFID tag wherein the RFID tag includes electronic information pertaining to the at least one transaction;
providing an interrogation facility; and
causing the interrogation facility to interrogate the RFID tag and receive the electronic information.

2. The method of claim 1 wherein the printed information comprises a bill.

3. The method of claim 1 wherein the printed information comprises a statement of transactions.

4. The method of claim 1 wherein the electronic information comprises account transaction information.

5. The method of claim 1 wherein the electronic information comprises account payment information.

6. The method of claim 1 wherein the electronic information comprises payee information.

7. The method of claim 6 wherein the payee information comprises address information

8. The method of claim 1 wherein the interrogation facility comprises a computer.

9. The method of claim 1 wherein the interrogation facility comprises a mail transaction facility.

10. The method of claim 1 wherein the interrogation facility comprises a bill transaction facility.

11. A bill, comprising:
printed transaction information; and
an RFID tag with electronic information pertaining to the transaction.

12. A bill transaction facility, comprising:
an interrogation facility adapted to initiate RFID communication and read RFID transaction information; and
a computing facility adapted to store the transaction RFID information, present the transaction information on a display facility, and communicate the transaction information to a payment facility.

13. The facility of claim 12 wherein the computing facility comprises a notebook computer.

14. The facility of claim 12 wherein the computing facility comprises a personal digital assistant.

15. The facility of claim 12 wherein the computing facility comprises a cell phone.

16. The facility of claim 12 wherein the computing facility comprises an email facility.

17. The facility of claim 12 wherein the computing facility comprises an instant messaging facility.

18. The facility of claim 12 wherein the computing facility comprises a portable bill pay facility.

19. The facility of claim 12 wherein the payment facility comprises a web based payment facility.

20. The facility of claim 12 wherein the payment facility comprises a local program.

21-60. (canceled)
